(19) United States
(12) Patent Application Publication
(10) Pub. No.: US 2025/0329003 A1
(43) Pub. Date: Oct. 23, 2025

(54) RIPENESS DETERMINATION SYSTEM AND RIPENESS DETERMINATION METHOD USING IMAGE PROCESSING

(71) Applicant: TOPPAN HOLDINGS INC., Tokyo (JP)

(72) Inventors: Ryoichi FUKAI, Taito-ku (JP); Atsushi SHIGA, Taito-ku (JP); Fumitaka UETO, Taito-ku (JP); Shinya TAKAHASHI, Taito-ku (JP); Michitaka HATA, Taito-ku (JP); Satoko NATSUBORI, Taito-ku (JP)

(73) Assignee: TOPPAN HOLDINGS INC., Tokyo (JP)

(21) Appl. No.: 19/252,606

(22) Filed: Jun. 27, 2025

Related U.S. Application Data
(63) Continuation of application No. PCT/JP2023/044261, filed on Dec. 11, 2023.

(30) Foreign Application Priority Data
Dec. 27, 2022 (JP) 2022-210621

(51) Int. Cl. G06T 7/00; G06T 7/60; G06T 7/90

(52) U.S. Cl. CPC G06T 7/0002; G06T 7/60; G06T 7/90; G06T 2207/10024; G06T 2207/20081; G06T 2207/30128; G06T 2207/30204

(57) ABSTRACT

A ripeness determination system and a ripeness determination method that include determining a degree of climacteric ripeness of a melon based on at least two factors obtained from an image of a stem of the melon, and determining whether the melon is ripe to eat based on the degree of climacteric ripeness.

### CROSS-REFERENCE TO RELATED APPLICATIONS

The present application is a continuation of and claims the benefit of priority to International Application No. PCT/JP2023/044261, filed Dec. 11, 2023, which is based upon and claims the benefit of priority to Japanese Application No. 2022-2210621, filed Dec. 27, 2022. The entire contents of these applications are incorporated herein by reference.

### BACKGROUND OF THE INVENTION

### Field of the Invention

Embodiments of the present invention relate to a ripeness determination system and a ripeness determination method.

### Description of Background Art

In recent years, Japanese consumption of fruit and vegetables has been declining. This trend is particularly strong for melons, and many regions are in danger of brand extinction. While melons are highly regarded for their quality by wholesalers and middlemen, consumer demand is declining. Therefore, rebranding is urgently needed to avoid the risk of brand extinction. One particular concern of farmers who produce fruits that require climacteric ripening, such as melons, is that the quality of the fruit is not well communicated to consumers since it is difficult for them to know when the best time to eat the fruit is.

The methods for communicating to consumers when the fruit is ripe to eat include writing the date of the best time to eat on the sales channel, mechanically determining the progress of climacteric ripening, and using images of melon skin to determine the best time to eat.

See, for example, JP H08-178912 A, WO 2018/003506, JP 2006-138771 A, JP 2006-226775 A, JP H11-173985 A, JP 2004-294108 A, JP 2020-176976 A, and JP 2021-089179 A. The entire contents of these publications are incorporated herein by reference.

### SUMMARY OF THE INVENTION

A ripeness determination system according to an embodiment includes processing circuitry configured to determine a degree of climacteric ripeness of a melon based on at least two factors obtained from an image of a stem of the melon, and determine whether the melon is ripe to eat based on the degree of climacteric ripeness.

A ripeness determination method according to an embodiment includes determining, by processing circuitry, a degree of climacteric ripeness of a melon based on at least two factors obtained from an image of a stem of the melon, and determining, by the processing circuitry, whether the melon is ripe to eat based on the degree of climacteric ripeness

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an example configuration for implementing a ripeness determination system according to an embodiment;

FIG. 2 is a diagram illustrating an example configuration of a ripeness determination system implemented using a dedicated application executed by a control device in a server;

FIG. 3 is a diagram illustrating an example of a melon to which a sticker is attached, which provides a two-dimensional code that enables access to the server;

FIG. 4A is a diagram illustrating an example of display content displayed on a display device of a terminal before image capture;

FIG. 4B is a diagram illustrating an example of display content displayed on the display device of the terminal during image capture;

FIG. 5 shows an example of a resizing process;

FIG. 6 shows an example of a trimming process using a mount and a second frame;

FIG. 7 shows an example of replacing the blue color of the background of the stem in an image with black;

FIG. 8 schematically shows an example of a procedure for object translation and angle correction (tilt correction) by affine transformation;

FIG. 9 is a diagram illustrating an example of a procedure of a climacteric ripeness degree determination process performed by a climacteric ripeness degree determination unit;

FIG. 10 shows an example of the change over time of a stem of a melon after harvest;

FIG. 11 shows example images before and after removing the color components (yellow to brown) of the stem that increase with the progress of climacteric ripening;

FIG. 12A illustrates binarization of images when calculating a dimensional measurement;

FIG. 12B illustrates counting of the number of pixels in an image when calculating a dimensional measurement;

FIG. 13 illustrates a process when a stem end in an image has a pointed shape;

FIG. 14A is a diagram illustrating an example of a procedure for calculating a degree of climacteric ripeness by a climacteric ripeness degree calculation process;

FIG. 14B is a diagram schematically illustrating the range of b in each class shown in step S44 in FIG. 14A;

FIG. 14C is a diagram illustrating a modified example of step S44 in FIG. 14A;

FIG. 15 shows an example (part 1) of an image used in a climacteric ripeness degree determination process;

FIG. 16 shows an example (part 2) of an image used in a climacteric ripeness degree determination process;

FIG. 17 shows an example (part 3) of an image used in a climacteric ripeness degree determination process;

FIG. 18 shows a table that summarizes the information obtained from each of the images in FIGS. 15 to 17;

FIG. 19 is a diagram illustrating an example of a procedure of a ripeness determination process performed by a ripeness determination unit;

FIG. 20 is a diagram illustrating a modified example of the system shown in FIG. 1;

FIG. 21 is a diagram schematically illustrating a procedure for obtaining a degree of climacteric ripeness or ripeness determination result using an AI (Artificial Intelligence) model; and

FIG. 22 is a diagram illustrating an example of a basic operation of a ripeness determination system.

### DETAILED DESCRIPTION OF THE EMBODIMENTS

Embodiments will not be described with reference to the drawings, wherein like reference numerals designate corresponding or identical elements throughout the various drawings.

The progress of climacteric ripening of melons varies depending on the storage conditions before consumption, and also depending on the variety of melons and time of year, making it difficult to determine whether a melon is ripe to eat. In addition, some varieties of melons do not have a reticulate pattern on their surface, and some have little change in color, making it difficult to determine whether a melon is ripe to eat from the condition of their outer skin.

According to one aspect, the present invention aims to provide a ripeness determination system and a ripeness determination method capable of easily determining whether a melon is ripe to eat. Accordingly, in one example, whether melons are ripe to eat can be easily determined.

### System Configuration

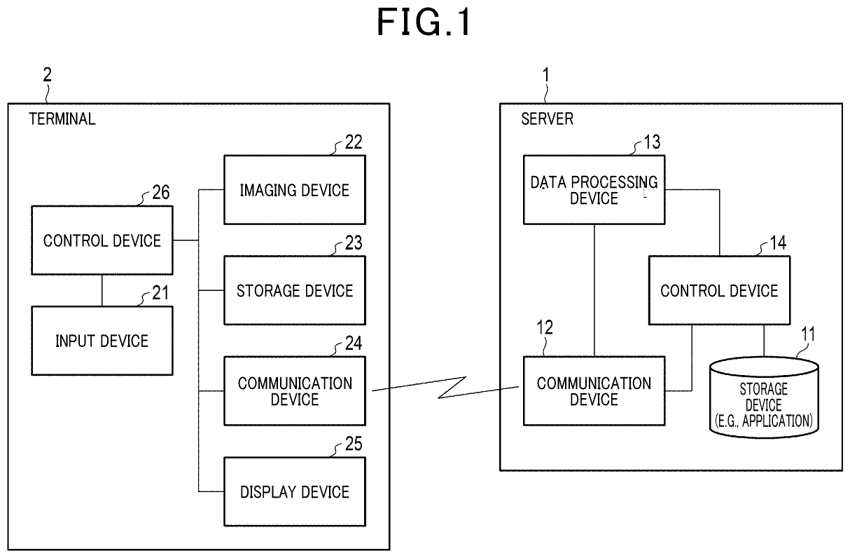

FIG. 1 is a diagram illustrating an example configuration for implementing a ripeness determination system according to an embodiment.

FIG. 1 shows a server 1 and a terminal 2. A ripeness determination system according to the present embodiment is provided in at least one of the server 1 and the terminal 2. The following description will be given of an example in which the ripeness determination system is provided in the server 1. The ripeness determination system is implemented using a computer program in the server 1. Further, some or all of the functions of the ripeness determination system may be provided in the terminal 2.

The server 1 corresponds to a computer (information processing device) that is managed by an administrator on a network (cloud). The terminal 2 corresponds to an information device, such as a smartphone, a tablet terminal or a personal computer, owned by a consumer.

The server 1 includes a storage device 11, a communication device 12, a data processing device 13, a control device 14, and the like.

The storage device 11 stores programs and data executed by the control device 14. The above programs include an application program (hereinafter, “dedicated application”) that implements the ripeness determination system. The dedicated application has a function that prompts the user to capture an image of the melon stem in response to access to the server 1 from the terminal 2, acquires the captured image of the stem, determines whether the melon is ripe to eat from the image, and notifies the terminal 2 of the determination result. The term “ripe to eat” here means at the best time to eat.

The communication device 12 transmits and receives information to and from the terminal 2.

The data processing device 13 performs various image processing and calculation processing related to ripeness determination under the control of the control device 14.

The control device 14 corresponds to a processor that executes programs, and controls the operations of the storage device 11, the communication device 12 and the data processing device 13.

The terminal 2 includes an input device 21, an imaging device 22, a storage device 23, a communication device 24, a display device 25, a control device 26, and the like.

The input device 21 is a device through which the consumer performs various input operations.

The imaging device 22 corresponds to a camera that captures and generates an image of a target object.

The storage device 23 stores programs and data executed by the control device 14, and includes ROM (Read Only Memory), RAM (Random Access Memory), and the like. The above programs include an application program that accesses the server 1 based on the information of the two-dimensional code recognized through the imaging device 22.

The communication device 24 transmits and receives information to and from the server 1.

The display device 25 corresponds to a display that displays information such as images captured with the imaging device 22, the ripeness determination result, and the like.

The control device 26 corresponds to a processor that executes programs, and controls the operations of the input device 21, the imaging device 22, the storage device 23, the communication device 24 and the display device 25.

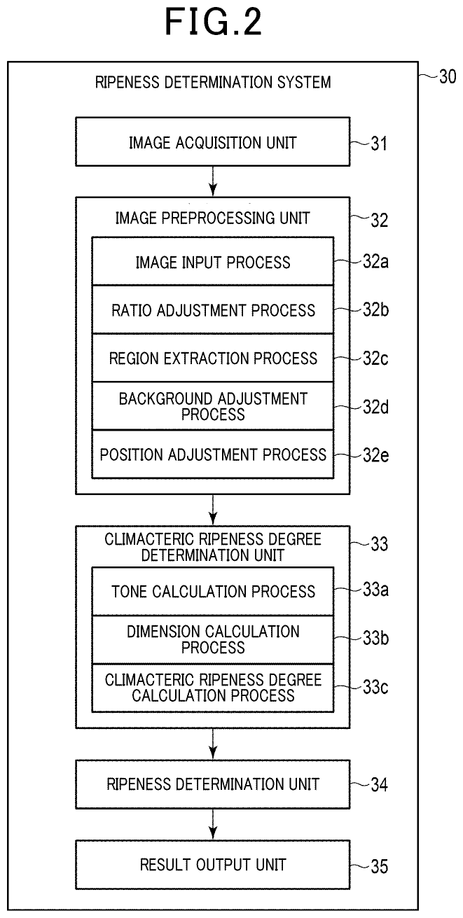

FIG. 2 is a diagram illustrating an example configuration of a ripeness determination system implemented using a dedicated application executed by the control device 14 in the server 1.

The ripeness determination system 30 shown in FIG. 2 includes an image acquisition unit 31, an image preprocessing unit 32, a climacteric ripeness degree determination unit 33, a ripeness determination unit 34 and a result output unit 35 as various functions. However, not all of these functions are necessarily required, and some may not be necessarily provided. For example, the ripeness determination system 30 may be configured without the image preprocessing unit 32.

The image acquisition unit 31 performs a process (image acquisition process) for acquiring an image of the stem of the melon from the terminal 1.

The image preprocessing unit 32 processes the image acquired by the image acquisition unit 31 (image preprocessing) before it is used by the climacteric ripeness degree determination unit 33. The image preprocessing includes an image input process 32a, a ratio adjustment process 32b, a region extraction process 32c, a background adjustment process 32d and a position adjustment process 32e. However, not all of these image preprocessing steps are necessarily required, and some or all of them may not be necessarily performed.

The image input process 32a inputs the image acquired by the image acquisition unit 31 to the image preprocessing unit 32.

The ratio adjustment process 32b adjusts the size of the image to be processed (for example, the image input by the image input process 32a) to the size of a predetermined reference image.

The region extraction process 32c extracts a predetermined region from the image to be processed (for example, the image whose size has been adjusted by the ratio adjustment process 32b).

The background adjustment process 32d changes the image portion corresponding to the background of the stem of the image to be processed (for example, the image of the region extracted by the region extraction process 32c) to a specific color based on a predetermined color of the mount, which will be described later.

The position adjustment process 32e moves the stem in the image to be processed (for example, the image input by the image input process 32a) to the center of the image and rotates the stem to orient the longitudinal direction of the stem in a predetermined direction (for example, horizontal direction).

The climacteric ripeness degree determination unit 33 obtains information on the color and shape of the stem from the image of the stem processed by the image preprocessing unit 32, and performs a process (climacteric ripeness degree determination process) to determine a degree of climacteric ripeness of the melon based on the obtained information on the color and shape. The climacteric ripeness degree determination process includes a tone calculation process 33a, a dimension calculation process 33b and a climacteric ripeness degree calculation process 33c.

The tone calculation process 33a uses the image of the stem to calculate a percentage of the color of the stem that increases or decreases with the progress of climacteric ripening of the melon.

The dimension calculation process 33b uses the image of the stem to calculate a thickness dimension of the stem that decreases with the progress of climacteric ripening of the melon.

The climacteric ripeness degree calculation process 33c uses the result calculated by the tone calculation process 33a and the result calculated by the dimension calculation process 33b to calculate a degree of climacteric ripeness.

The ripeness determination unit 34 performs a process (ripeness determination process) to determine whether the melon is ripe to eat based on the degree of climacteric ripeness determined by the climacteric ripeness degree determination unit 33.

The result output unit 35 performs a process (result output process) to notify the terminal 1 of the result determined by the ripeness determination unit 34.

In the following description, details of the image acquisition unit 31, the image preprocessing unit 32, the climacteric ripeness degree determination unit 33, the ripeness determination unit 34 and the result output unit 35 will be described in sequence.

### Image Acquisition Unit 31

As described above, the image acquisition unit 31 performs a process (image acquisition process) for acquiring an image of the stem of the melon from the terminal 1. The image acquired by the image acquisition unit 31 is a visible image of the stem of the melon. The visible image may be a still image acquired by image capture with an imaging device or may be a single image acquired from a video. The visible image of the stem of the melon does not necessarily have to be acquired by image capture, and may be acquired by any method other than image capture. When an image is acquired by image capture, the following methods can be used as the imaging method.

1) After an image of the entire melon is captured, the portion including the stem is extracted in subsequent image preprocessing.

2) An image of the region including the stem is captured.

3) A mount having an area equivalent to the region to be extracted in image preprocessing is attached to the stem, and image capture is performed. In this example, the mount is a real object printed on paper or the like, but it is not limited thereto. The mount may be a real object printed on paper or the like, or may be an image displayed on a display or the like.

These methods can be appropriately selected and implemented depending on the situation.

The following description will be given of a case where image capture is performed using the method 3) above.

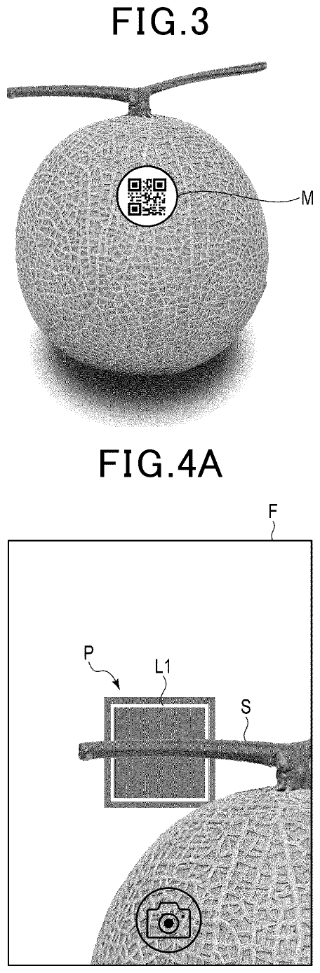

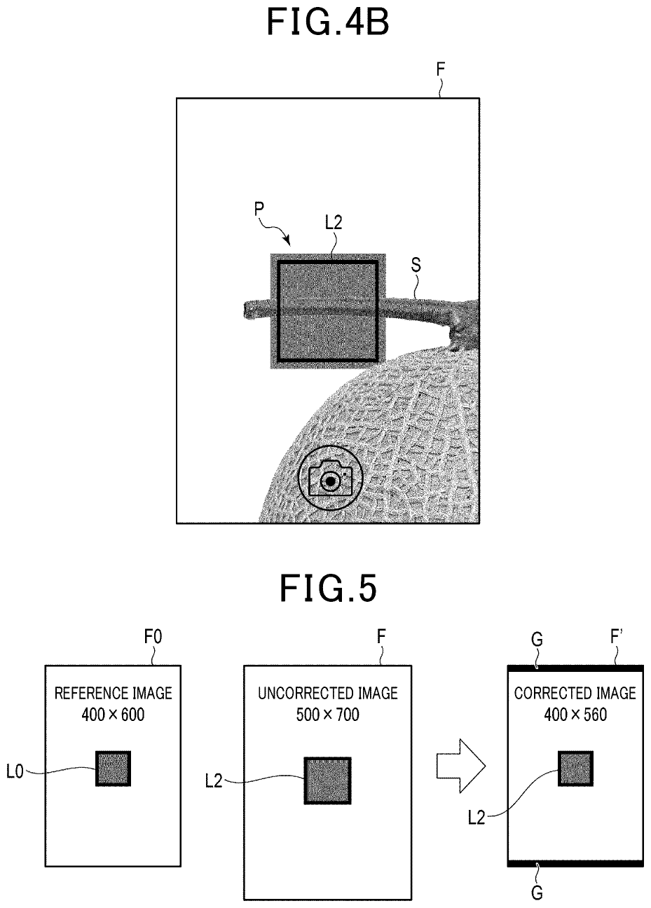

With reference to FIGS. 3, 4A and 4B, the functions of the image acquisition unit 31 will be described in detail.

FIG. 3 is a diagram illustrating an example of a melon to which a sticker M is attached, which provides a two-dimensional code that enables access to the server 1. FIGS. 4A and 4B are diagrams illustrating examples of display content displayed on the display device 25 of the terminal 2 before and during image capture, respectively, when a consumer captures an image of a stem S of a melon with the imaging device 22 of the terminal 2 according to the information provided by a dedicated application on the accessed server 1.

For example, according to the instructions or the like attached to the melon obtained, the consumer reads the two-dimensional code on the sticker M attached to the melon as shown in FIG. 3 or in the instructions or the like, with the imaging device 22 of the terminal 2, and accesses the corresponding site (server 1). As a result, access is performed from the terminal 2 to the server 1, and information explaining how to determine when the melon is ripe to eat is sent from the dedicated application on the server 1 (specifically, the image acquisition unit 31 of the ripeness determination system 30) to the terminal 2 via the communication devices 12 and 24, and displayed on the display device 25. Instead of the above two-dimensional code, a URL (Uniform Resource Locator) may be provided on the sticker M or in the instructions or the like. In this case, access can be performed to the corresponding site (server 1) based on the URL.

The instruction on how to determine when the melon is ripe to eat may include a message such as, for example, “Attach a mount to the rear side of the thin part of the melon stem and capture an image while aligning the frame on the mount with another frame in the image.” In addition, samples of captured images, illustrations or pictures showing the image-capturing situation may also be attached as supplementary information.

Following the instruction on how to determine when the melon is ripe to eat, the consumer captures an image of the stem S and the mount P with a predetermined color attached to the rear side of the stem S, as shown in FIG. 4A. Specifically, image capture is performed while aligning a first frame L1 pre-marked on the mount P with a second frame L2 (guide) displayed on the display device 25 of the terminal 2. The captured image is sent from the terminal 2 to the server 1.

As a result, the image acquisition unit 31 acquires an image of the stem S and the mount P with a predetermined color attached to the rear side of the stem S. Specifically, the image acquisition unit 31 acquires an image captured while aligning the first frame L1 pre-marked on the mount P with the second frame L2 displayed on the display device 25 of the terminal 2.

### Mount

The mount P may be a square mount with one side of about 3 cm to 5 cm, for example, and is attached to the rear side of the thin part of the stem S. The color of the mount P may be, for example, blue. In order to facilitate attachment of the mount P to the stem S, the surface of the mount P may be formed of a sticker-like material. The mount P may be made of paper or may be made of any material other than paper.

Such a mount P is used for two purposes.

### First Purpose of Mount P

The first purpose of the mount P is to facilitate the region extraction process 32c. The region extraction process 32c specifies a predetermined region from the visible image that has been input to be used in the climacteric ripeness degree determination process, and extracts the image of that region. The use of the mount P for this process makes it possible to extract an image based on a predetermined range of the size of the mount P or the size of the second frame L2, preventing occurrence of errors caused by range specification.

### Second Purpose of Mount P

The second purpose of the mount P is to facilitate the background adjustment process 32d. In the background adjustment process 32d, the stem S is recognized as the foreground, other objects in the image are recognized as the background, and the background is converted to a color, such as black, that is not relevant to subsequent processing. In this process, if a background having the same color as that of the stem S is imaged, the background may not be recognized as the background of the stem S. Therefore, the use of the mount P makes it possible to prevent a component other than the stem S, which may be recognized as the background, from being imaged, facilitating the background adjustment process 32d. As a result, the ripeness determination process can be performed more easily compared with conventional methods, without environmental constraints.

### Image Capture Using Mount

As shown in FIG. 4A, an image F displayed on the display device 25 of the terminal 2 shows the stem S of the melon and the mount P. The mount P has the pre-marked first frame L1. Further, as shown in FIG. 4B, in the image F displayed on the display device 25 of the terminal 2, the second frame L2 is displayed in the center of the image. Image capture is performed while aligning the first frame L1 with the second frame L2.

The first frame L1 and the second frame L2 may differ in at least one of color and shape. This makes it easier for the consumer to align these frames when performing image capture. For example, a color complementary to the color of the stem can be used as the color of the first frame L1 or the second frame L2 to make the color of the frame conspicuous. Further, the first frame L1 or the second frame L2 may be in the form of, for example, a dotted or dashed line that is partially interrupted, or may have no lines except at the four corners.

By aligning the second frame L2 with the first frame L1 marked on the mount P during image capture, the coordinate information of the four corners of the second frame L2 can be used as a reference for the region to be extracted by the region extraction process 32c, further facilitating the region extraction process 32c. Further, it can also be used as a guide for determining how close to the object to get when acquiring an image. Furthermore, since the first frame L1 is marked inside the edge of the mount P, it is possible to ensure that the region to be extracted does not extend outside the mount P due to errors that occur during image capture or trimming.

The imaging method described above is not limited to this example. For example, if the same region extraction as described above can be performed in the region extraction process 32c, image capture may be performed by other methods.

### Image Preprocessing Unit 32

As described above, the image preprocessing unit 32 processes the image acquired by the image acquisition unit 31 (image preprocessing) before it is used by the climacteric ripeness degree determination unit 33. The image preprocessing includes an image input process 32a, a ratio adjustment process 32b, a region extraction process 32c, a background adjustment process 32d and a position adjustment process 32e. In the following description, details of these processes will be described in sequence.

### Image Input Process 32a

As described above, the image input process 32a inputs the image acquired by the image acquisition unit 31 to the image preprocessing unit 32.

The image input process 32a inputs the image acquired by the image acquisition unit 31 to the image preprocessing unit 32 after adjusting the image, if necessary, into a format that can be appropriately processed in the ratio adjustment process 32b, the region extraction process 32c, the background adjustment process 32d and the position adjustment process 32e. However, if the image format is already in a format suitable for each process, there is no need to adjust the format again.

For example, a common file format applied to still images used on computers may be used as the adjusted format.

### Ratio Adjustment Process 32b

As described above, the ratio adjustment process 32b adjusts the size of the image to be processed (for example, the image input by the image input process 32a) to the size of a predetermined reference image.

In the dimension calculation process 33b described later, the thickness dimension of the stem shown in the image is calculated by calculating the number of pixels in the portion corresponding to the stem in the image. Here, the size of the input image varies depending on the type of the device used to capture the image, and the thickness dimension of the stem may not be calculated according to a fixed standard. Therefore, the ratio adjustment process 32b resizes the image to the size of the reference image while maintaining the aspect ratio of the image.

FIG. 5 shows an example of a resizing process.

FIG. 5 illustrates an example of conversion from an uncorrected image F to a corrected image F′ based on the reference image F0.

In this example, if the horizontal and vertical pixel counts of the reference image F0 is 400×600 and the uncorrected image F has the horizontal and vertical pixel counts of 500×700, the size of the uncorrected image F is converted so that the corrected image F′ has the horizontal and vertical pixel counts of 400×560 without changing the aspect ratio.

Specifically, the size of the uncorrected image F is converted at a magnification of ⅘ so that the horizontal pixel count 400 of the corrected image F′, among the horizontal and vertical pixel counts, matches the horizontal pixel count 400 of the reference image F0, while maintaining the aspect ratio of the uncorrected image F. The size of the second frame L2 is also converted at the same magnification. As a result, the size of the second frame L2 shown in the corrected image F′ becomes the same as the size of the frame L0 shown in the reference image F0.

In this example, since the reference image F0 and the corrected image F′ differ in the aspect ratio, the vertical pixel count of the reference image F0 is 600 while the vertical pixel count of the corrected image F′ is 560, resulting in a missing region G in the vertical direction of the corrected image F′ relative to the size of the reference image F0. The missing region G is complemented with pixels having predetermined color information, such as black.

The basic resizing procedure will be described below.

1) First, the size (vertical and horizontal pixel counts) of the reference image F0 is determined, and either the vertical or horizontal pixel count of the reference image is selected.

2) Next, the size (vertical and horizontal pixel counts) of the uncorrected image F is detected.

3) Finally, the size of the uncorrected image F is converted, without changing the aspect ratio, to match the pixel count selected in 1) above to obtain the corrected image F′. Further, pixels having a predetermined color, such as black, are added to the missing region G to match the size of F0. Here, it is not necessary to add pixels having a predetermined color to the missing region G if it does not affect the region extraction process 32c.

Such a resizing process makes it possible to calculate the thickness dimension of the stem according to a fixed standard in the dimension calculation process 33b regardless of the device used to capture the image.

The resizing process described above is not necessarily required. If the dimension calculation process can be finally performed according to a fixed standard, the resizing process may be omitted or other processes may be performed.

### Region Extraction Process 32c

As described above, the region extraction process 32c extracts a predetermined region from the image to be processed (for example, the image whose size has been adjusted by the ratio adjustment process 32b).

In the region extraction process 32c, the range of the region to be subjected to the climacteric ripeness degree determination process by the climacteric ripeness degree determination unit 33 is trimmed in advance (trimming process). When image capture is performed using the mount P as described above, it is preferred to perform the trimming process using the mount P and the second frame L2.

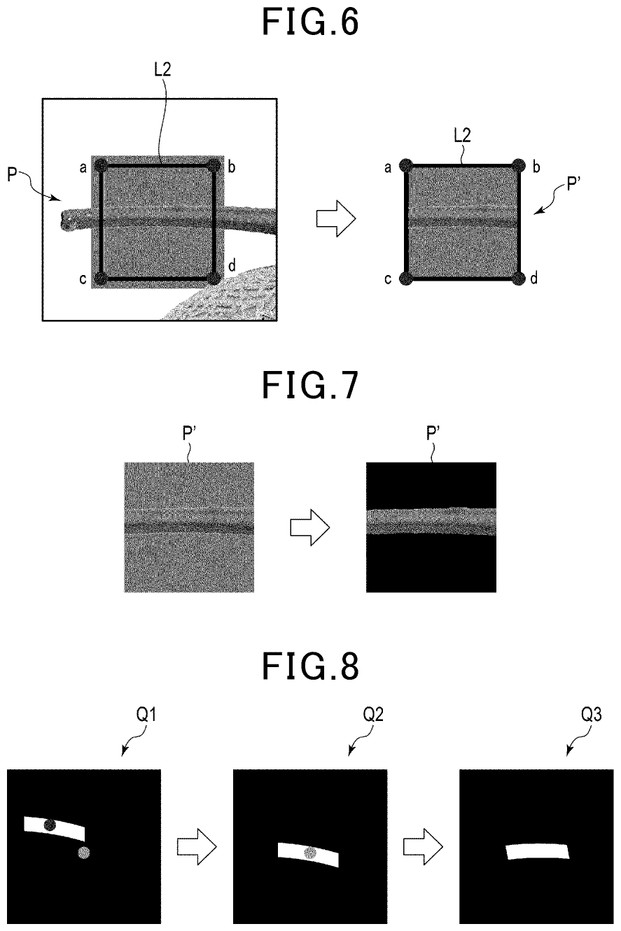

FIG. 6 shows an example of the trimming process using the mount P and the second frame L2.

The trimming process is performed based on the size of the mount P and the second frame L2. In the example of FIG. 6, the trimming process is performed based on the size of the second frame L2. After the trimming process, an image P′ of a predetermined region is extracted based on the coordinate information of the four corner points a, b, c and d of the second frame L2.

Such a trimming process makes it possible to extract the image region based on a predetermined range, preventing occurrence of errors caused by range specification.

### Background Adjustment Process 32d

As described above, the background adjustment process 32d changes the image portion corresponding to the background of the stem of the image to be processed (for example, the image of the region extracted by the region extraction process 32c) to a specific color based on the color of the mount.

In the background adjustment process 32d, the stem in the image is recognized as the foreground, and other objects in the image are recognized as the background and converted to a color, such as black, that is not relevant to subsequent processing.

In this process, if a background having the same color as that of the stem of the melon is imaged, the background may not be recognized as the background of the stem S. Therefore, it is desired to perform image capture using the above-mentioned mount P and extract the region in which only the foreground is imaged by the region extraction process 32c. Specifically, the color of the background of the stem in the image P′ (color of the mount P) is replaced with a predetermined color.

FIG. 7 shows an example of replacing the blue color of the background of the stem in the image P′ with black.

In the example of FIG. 7, the color of the background of the stem in the image P′ is blue (color of the mount P), and the color of this portion is replaced with black. Since the region extraction process 32c makes it possible to prevent a component other than the mount P, which may be recognized as the background, from being imaged, facilitating the background adjustment process 32d.

Specifically, a threshold is set for the color information of each pixel in the image P′, and if there is a pixel having a value exceeding the threshold, the value of the pixel is converted to 0 (value corresponding to black) (hereinafter, “color threshold process”). For example, a threshold may be set so that the blue value exceeds the threshold, and only blue components are filtered out to remove the blue components. Thus, an image of the remaining color components can be obtained. In this example, the blue mount P, which does not have a numerical value close to the value of the color components of the stem (green to yellow or brown), is used, so the blue components of the background can be easily removed while the color components of the stem (green to yellow or brown) remain.

Such a color threshold process makes it possible to obtain information on the region of the stem excluding the background of the stem and its color components.

The color of the mount P is not limited to blue, and may be any other color as long as it is a color that makes it easy to remove the color of the background. Further, color components can be represented by color systems such as HSV and L*a*b*, in addition to RGB, but any color system may be used as long as it facilitates a color threshold process. In this example, the color defined by the hue (H) of the HSV color space is used for the color of the mount P.

### Position Adjustment Process 32e

As described above, the position adjustment process 32e moves the stem in the image to be processed (for example, the image input by the image input unit 32) to the center of the image and rotates the stem to orient the longitudinal direction of the stem in a predetermined direction (for example, horizontal direction).

In the position adjustment process 32e, before the position adjustment of the stem is performed, binarization is performed on the image to be processed to make the stem portion white and the background of the stem black. The binarization may be performed using the threshold processing technique described above. After the binarization, an affine transformation is performed with the white portion of the stem as the object.

FIG. 8 schematically shows an example of a procedure for object translation and angle correction (tilt correction) by affine transformation.

An image Q1 in FIG. 8 shows the state before the object is moved. An image Q2 shows the state in which the object has been moved to the center of the image. An image Q3 shows the state in which the tilt of the object has been corrected so that the longitudinal direction of the object is oriented in the horizontal direction.

The circle in the object shown in the image Q1 represents the center of gravity of the object.

The circles in the center of the images Q1 and Q2 represent the center of the image, respectively.

The affine transformation here is composed of two steps, i.e., translation and angle correction (tilt correction), as follows.

1) The deviation between the center of the image Q1 and the center of gravity of the object is calculated, and the object is moved to the center of the image as shown in the image Q2.

2) The tilt of the object in the image Q2 is calculated, and the tilt is corrected.

Such an affine transformation makes it possible to appropriately correct the position of the stem in the image, ensuring accurate ripeness determination process.

The above translation and angle correction may be performed using not only the affine transformation but also other methods.

### Climacteric Ripeness Degree Determination Unit 33

As described above, the climacteric ripeness degree determination unit 33 shown in FIG. 1 obtains information on the color and shape of the stem from the image of the stem processed by the image preprocessing unit 32, and performs a process (climacteric ripeness degree determination process) to determine a degree of climacteric ripeness of the melon based on the obtained information on the color and shape. The climacteric ripeness degree determination process includes a tone calculation process 33a, a dimension calculation process 33b and a climacteric ripeness degree calculation process 33c.

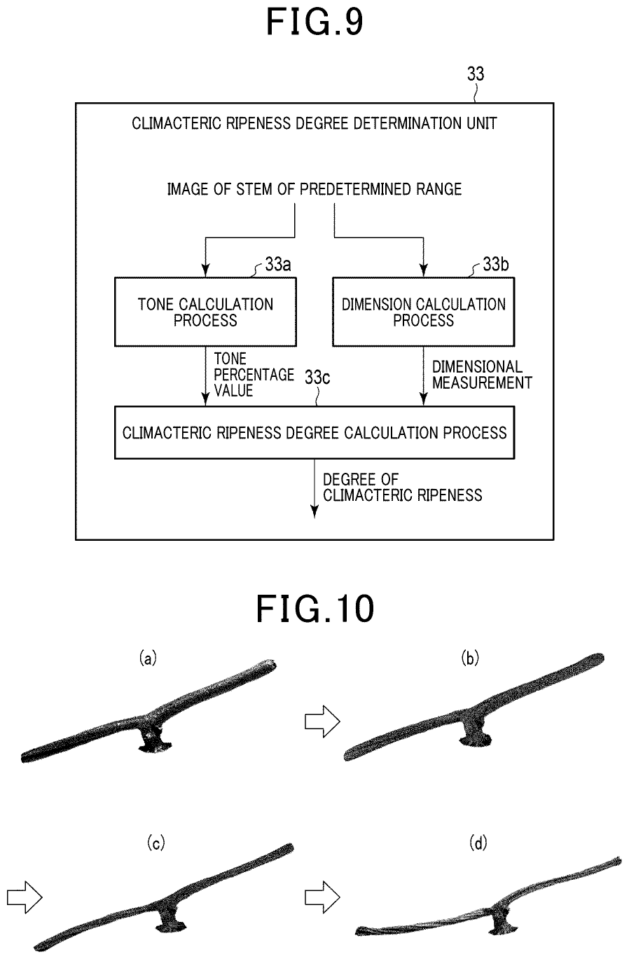

FIG. 9 is a diagram illustrating an example of a procedure of the climacteric ripeness degree determination process performed by the climacteric ripeness degree determination unit 33.

The tone calculation process 33a uses the image generated by the image preprocessing unit 32 to calculate a percentage (hereinafter, “tone percentage value”) of the color of the stem that increases or decreases with the progress of climacteric ripening of the melon. The tone percentage value indicates the percentage of the area of the color region that decreases or increases with the progress of climacteric ripening of the melon to the area of the entire stem in the image.

The dimension calculation process 33b uses the image generated by the image preprocessing unit 32 to calculate a thickness dimension (hereinafter, “dimensional measurement”) of the stem that decreases with the progress of climacteric ripening of the melon. The dimensional measurement indicates the minimum thickness (dimension of the thinnest part) of the stem.

The climacteric ripeness degree calculation process 33c uses the tone percentage value calculated by the tone calculation process 33a and the dimensional measurement calculated by the dimension calculation process 33b to calculate a degree of climacteric ripeness. In the present embodiment, a larger value for the climacteric ripeness degree indicates unripeness, and a smaller value indicates advanced climacteric ripeness.

In the following description, details of the tone calculation process 33a, the dimension calculation process 33b and the climacteric ripeness degree calculation process 33c will be described in sequence.

### Tone Calculation Process 33a

As described above, the tone calculation process 33a calculates a percentage (tone percentage value) of the color of the stem that increases or decreases with the progress of climacteric ripening of the melon.

One of the characteristics that changes over time with the progress of climacteric ripening of melons is the change in color tone of the stem. In general, with the progress of climacteric ripening of melons, the yellow tone value increases and the green tone value decreases. The tone value herein refers to a color value in a predetermined color system (for example, hue in HSV color space).

FIG. 10 shows an example of the change over time of the stem of a melon after harvest.

The melon stem is observed to change in color and shape (or dimension) over time after harvest.

The color of the melon stem changes as follows in the order of (a), (b), (c) and (d) in FIG. 10.

“Dark green”→“Light green”→“Green mixed with yellow”→“Yellow or brown”

Therefore, among the tone components of the stem in the image, the tone components that increase or decrease with the progress of climacteric ripening of the melon is correlated with the number of days of climacteric ripening. In order to ascertain the progress of climacteric ripening, a tone percentage value is calculated by dividing the area of the region of the tone components that increase or decrease by the area of the entire stem. Each area can be represented by the number of pixels.

In this example, the tone percentage value of the green component that decreases with the progress of climacteric ripening is calculated by determining the ratio of the area of the green component region (color components of the unripe portion) remaining after removing the yellow to brown components in the HSV color space (color components of the ripe portion) to the region of the entire stem. A larger value for the tone percentage value of the green component indicates unripeness, and a smaller value indicates advanced climacteric ripeness. The tone percentage value is represented in the range of 0 or greater and 1 or less.

The following is an example of the procedure for calculating the tone percentage value.

1) The number of pixels in the region of the entire stem, excluding the background, is calculated.

2) The color components (yellow to brown) that increase with the progress of climacteric ripening are removed using the above-mentioned color threshold process.

3) The number of pixels in the green component region remaining after the removal is calculated.

4) The tone percentage value of the green component is calculated using the following calculation formula.

Tone percentage value=(number of pixels in green component region)/(number of pixels in the entire stem)

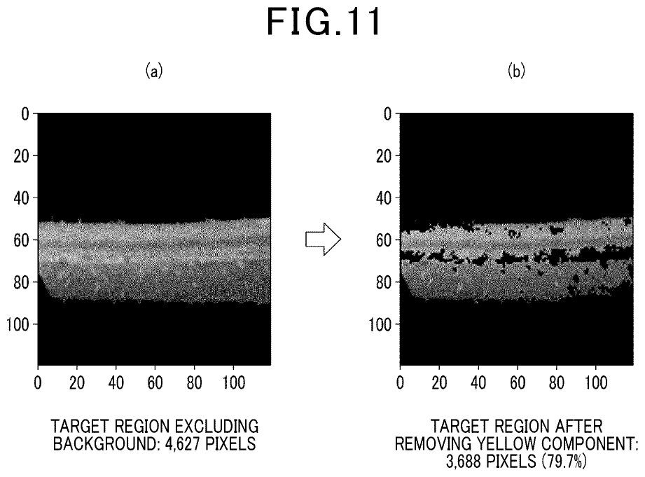

FIG. 11 shows example images before and after removing the color components (yellow to brown) of the stem that increase with the progress of climacteric ripening.

The image shown in FIG. 11 (a) is an image before the color components (yellow to brown) of the stem that increase with the progress of climacteric ripening is removed. In this image, the number of pixels calculated for the region excluding the background (region of the entire stem) is 4,627.

The image shown in FIG. 11 (b) is an image after the color components (yellow to brown) of the stem that increase with the progress of climacteric ripening are removed. In this image, the number of pixels calculated for the remaining green component region is 3,688.

In this case, the tone percentage value of the green component is 0.797 (=79.7%) according to the above calculation formula.

The above description shows the example of calculating the tone percentage value of the green component remaining after removing the yellow to brown components that increase with the progress of climacteric ripening. However, instead of the above, it is also possible to calculate the tone percentage value of the yellow to brown components remaining after removing the green components that decrease with the progress of climacteric ripening.

A smaller value for the tone percentage value of the yellow to brown components indicates unripeness, and a larger value indicates advanced climacteric ripeness. Accordingly, by calculating “1−(tone percentage value of yellow to brown color components),” a larger value indicates unripeness and a smaller value indicates advanced climacteric ripeness.

### Dimension Calculation Process 33b

As described above, the dimension calculation process 33b calculates a thickness dimension (dimensional measurement) of the stem that decreases with the progress of climacteric ripening of the melon.

One of the characteristics that changes over time with the progress of climacteric ripening of melons is the change in thickness dimension of the stem. In general, with the progress of climacteric ripening of melons, the thickness dimension of the stem decreases.

As shown in FIG. 10, the dimension and shape of the stem change as follows from (a) to (d) in FIG. 10.

“Thick and solid shape”→“Gradually thinning and twisting shape”

Therefore, the thickness dimension of the stem in the image is correlated with the number of days of climacteric ripening. In order to ascertain the progress of climacteric ripening, the thickness dimension of the stem is measured to calculate the dimensional measurement. A larger value for the dimensional measurement indicates unripeness, and a smaller value indicates advanced climacteric ripeness. In the present embodiment, the thickness dimension of the stem is represented by the number of pixels, but any unit (e.g., mm) that can represent the length, other than the number of pixels, may be used.

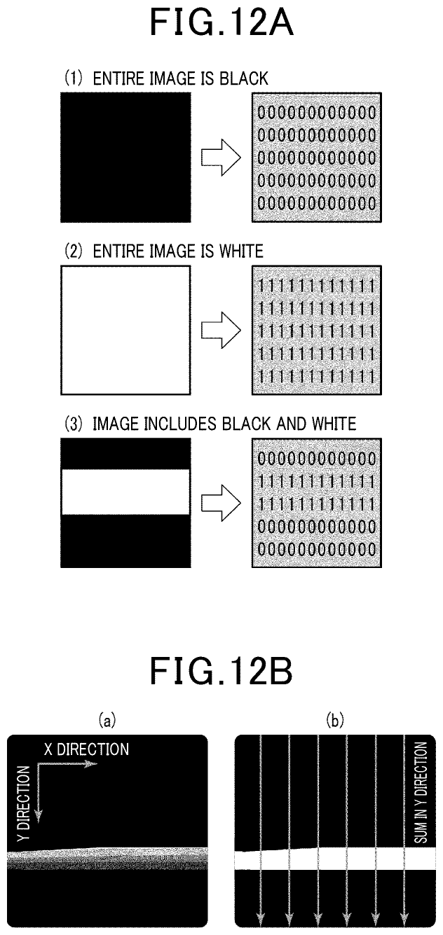

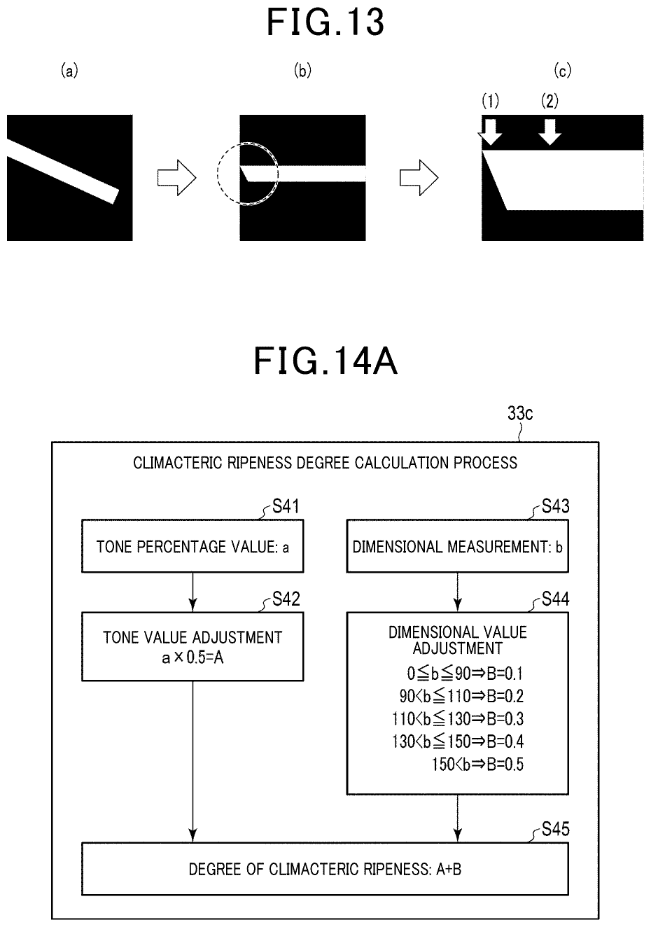

With reference to FIGS. 12A, 12B and 13, an example of a procedure for calculating a dimensional measurement will be described.

1) The image showing the stem is binarized, with the black portion in the image represented as “0” and the white portion represented as “1”.

If the entire region in the image is black, all the pixels arranged in a matrix in the image have a value of “0”, as shown in (1) in FIG. 12A. On the other hand, if the entire region in the image is white, all the pixels have a value of “1”, as shown in (2) in FIG. 12A. If part of the region in the image is white and the remaining portion is black, some pixels have a value of “1” and the remaining pixels have a value of “0”, as shown in (3) in FIG. 12A.

2) As shown in (a) in FIG. 12B, when the image showing the stem extending in the horizontal direction (X direction) of the image is binarized, information relatively close to (3) in FIG. 12A is obtained. In this case, the portion of the stem is represented by a value of “1”, and the background portion other than the stem is represented by a value of “0”. Then, as shown in (b) in FIG. 12B, the number of pixels arranged in the vertical direction (Y direction) of the image is counted for each column. As a result, X count values (X: the number of pixels in the horizontal direction of the image) are obtained. The X count values represent the thickness of each part of the stem.

3) Among the X count values, a minimum count value other than 0 is searched to identify the thinnest part of the stem in the image.

4) Depending on the shape of the stem end in the image, the thinnest part of the stem in the image may not be correctly identified. For example, when the angle correction (tilt correction) described above is performed, the state shown in (a) in FIG. 13 changes to the state shown in (b), in which the stem end in the image may have a pointed shape as indicated by the dotted line. If the number of pixels is counted in the vertical direction (Y direction) at the position (1) as shown in (c) in FIG. 13, the count value will be the minimum value.

Therefore, after both ends of the stem are removed, a search for a portion having a minimum count value other than 0 is performed on the portion other than both ends of the stem. For example, a search for a portion having a minimum count value other than 0 is performed on the center portion of the stem relative to the position (2) shown in (c) in FIG. 13. Then, the minimum count value other than 0 is calculated as the dimensional measurement.

### Climacteric Ripeness Degree Calculation Process 33c

As describe above, the climacteric ripeness degree calculation process 33c uses the tone percentage value calculated by the tone calculation process 33a and the dimensional measurement calculated by the dimension calculation process 33b to calculate a degree of climacteric ripeness.

The climacteric ripeness degree calculation process 33c calculates a degree of climacteric ripeness, which is represented in the range of 0 or greater and 1 or less, by a calculation process using the tone percentage value and the dimensional measurement. The tone percentage value is adjusted by a predetermined process to obtain a value A, the dimensional measurement is adjusted by a predetermined process to obtain a value B, and A and B are added together to calculate a degree of climacteric ripeness, which is represented in the range of 0 or greater and 1 or less.

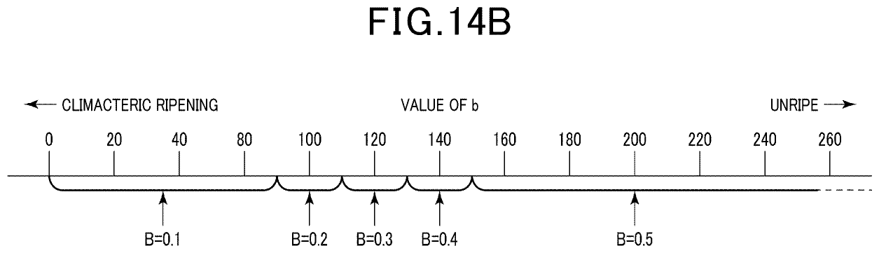

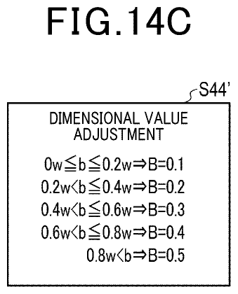

With reference to FIG. 14A, an example of a procedure for calculating a degree of climacteric ripeness by the climacteric ripeness degree calculation process 33c will be described.

1) The tone percentage value is designated a (step S41).

2) The tone percentage value a is a value that indicates the tone percentage of the green component that decreases with the progress of climacteric ripening of the melon, and is represented in the range of 0 or greater and 1 or less. As described above, a degree of climacteric ripeness is calculated using not only A but also B. The ratio of the weights of A and B may be set to “1:1”, for example, and the range of A may be adjusted to be 0 or greater and 0.5 or less (tone value adjustment). Here, the weighting coefficient for a is “0.5”, and the value obtained by calculating “a×0.5” is A (step S42).

However, the example shown in 2) above is merely an example, and the invention is not limited thereto. For example, depending on the variety of melon being handled and the harvest time, the ratio of weights may be changed to a ratio different from “1:1”, and accordingly the weighting coefficient multiplied by a may also be changed to a value different from “0.5”.

3) The dimensional measurement is designated as b (step S43).

4) The dimensional measurement b is a value that indicates the thickness dimension of the stem that decreases with the progress of climacteric ripening of the melon. In the embodiment, the range of b is assumed to be 50 pixels or greater and 250 pixels or less, and the possible range of the dimensional measurement b is divided into a plurality of classes (a plurality of ranges) so that B can be determined from b for each class. For example, classification is performed as shown in step S44 in FIG. 14A. Then, the value B is determined depending on which class the dimensional measurement b belongs to (step S44).

FIG. 14B schematically illustrates the range of b in each class shown in step S44 in FIG. 14A. In the example shown in FIG. 14B, the ranges of b corresponding to B=0.2, 0.3 and 0.4, respectively, are narrower than the ranges of b corresponding to B=0.1 and 0.5 so that the progress of climacteric ripening can be distinguished in relatively fine detail.

As described above, the range of b is assumed to be in the range of 50 pixels or greater and 250 pixels or less, and five ranges of B are set based on this assumption, but there may be cases where b is smaller than 50 pixels or greater than 250 pixels. In order to appropriately determine the value of B even in such cases, the lower limit of the smallest range among the five ranges of b is set to 0 and no upper limit is set for the largest range in step S44 in FIG. 14A.

In the example described above, the range of b is assumed to be 50 pixels or greater and 250 pixels or less and divided into 5 classes (5 ranges) shown in step S44 in FIG. 14A depending on the possible value of the dimensional measurement b, but is not limited thereto.

For example, in order to accommodate (generalize) cases where the range of b is other than 50 pixels or greater and 250 pixels or less, step S44 in FIG. 14A may be replaced with step S44′ shown in FIG. 14C. In step S44, the range of b in each class is invariant as shown in FIG. 14B, but in step S44′, the initial value of the thickness dimension of the stem of the melon at the time of harvest is set as a variant w, and the range of b in each class and the ratio of each range can be changed by using the formula including the variant w. In step S44′, w is assumed to be 200, but w can be changed to a value other than 200. The appropriate value of w (and the appropriate range of b in each class and the appropriate ratio of each range) varies depending on the variety of melon being handled and the harvest time. By storing the variety and harvest time in advance in the two-dimensional code described above, the burden on the user can be made negligible. The value of w may be stored in advance in a storage device accessible by the climacteric ripeness degree determination unit 33, and may be updated according to the variety and harvest time obtained from the two-dimensional code. In the examples described above, five classes are used in step S44 and step S44′, but the invention is not limited thereto. For example, the number of classes may be increased so that B can be classified in detail. This makes it possible to distinguish the progress of climacteric ripening in more detail, and for example, to deal with cases where the melon is over-ripe or under-ripe. The increase and decrease in the number of classes, in other words, the accuracy of determining the climacteric ripeness degree has a trade-off relationship with the data processing load and the size of data volume. Therefore, it is preferred that the value is appropriately set considering both of these. Further, the range of b that defines each class can be freely changed depending on the variety of the target melon and harvest time. Information in the form of a table or the like in which the range of b that defines each class is related to the variety of melon and harvest time may be stored in the storage device accessibly the climacteric ripeness degree determination unit 33.

5) Finally, the degree of climacteric ripeness is calculated by calculating “A+B” using A determined in step S42 and B determined in step S44 (step S45).

In the example described above, the degree of climacteric ripeness is calculated using two indices (criteria), A and B, but the number of indices is not limited thereto. Three or more indices may be used to calculate the degree of climacteric ripeness. In this case, even if one index has a large error due to individual differences or the like, the remaining two indices can be used to perform appropriate determination, and the determination accuracy can be relatively improved.

When using three indices, the degree of climacteric ripeness is calculated by adding not only A and B, but also another index C. The index C may be the degree of climacteric ripeness obtained by using AI technology described below. This results in more accurate determination results.

An appropriate value for the weighting coefficient of A (weighting coefficient multiplied by a used to calculate A) and an appropriate maximum value for each index such as A or B vary depending on the number of indices to be handled and the ratio of each index. In this case, the indices are adjusted in advance so that the sum of the indices is 1. For example, when three indices A, B and C are used and the ratio is 1:1:1, the maximum value of each index is set to 0.33.

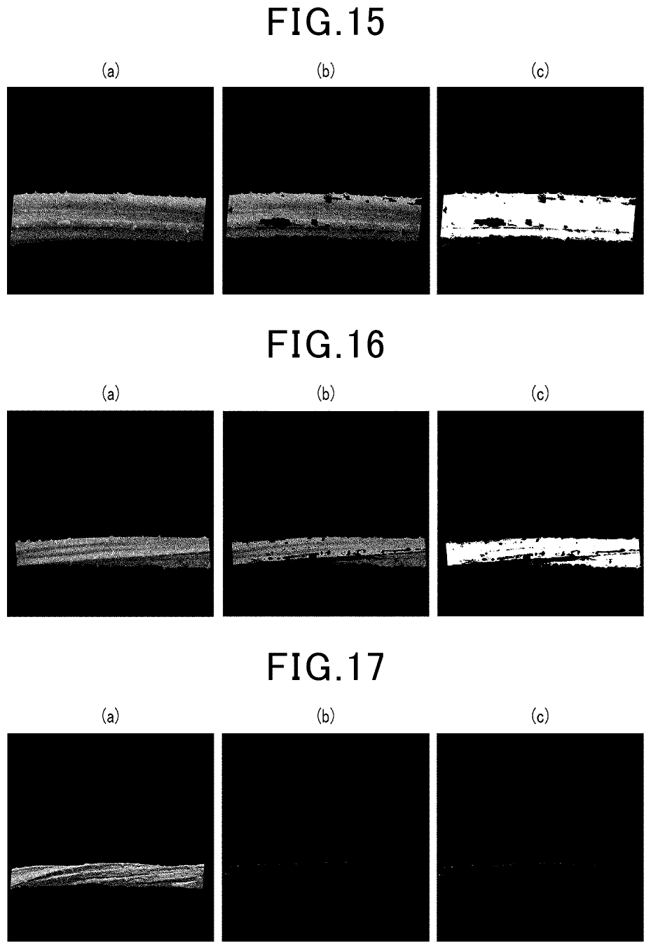

FIGS. 15 to 17 show examples of some images used in a climacteric ripeness degree determination process.

FIG. 15 shows an image acquired on the first day of imaging, FIG. 16 shows an image acquired three days after the first day of imaging, and FIG. 17 shows an image acquired one week after the first day of imaging.

In each of FIGS. 15 to 17, (a) shows an image that has been preprocessed, (b) shows an image in which color components (yellow to brown) of the stem that increase with the progress of climacteric ripening have been removed after the preprocessing, and (c) shows an image that has been binarized after the yellow to brown color components have been removed.

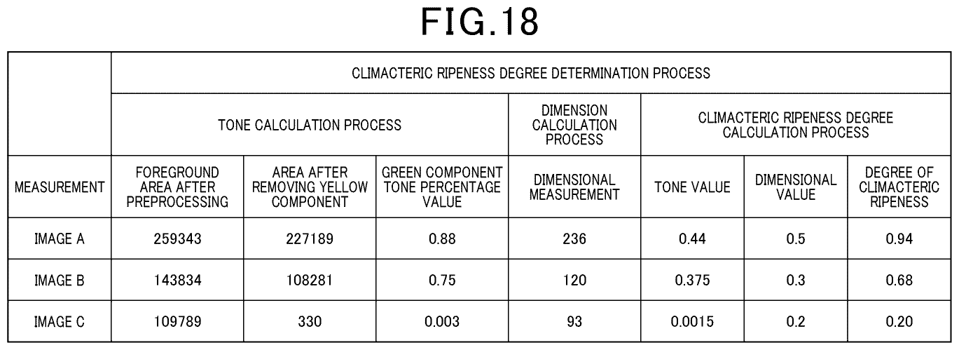

FIG. 18 shows a table that summarizes the information obtained from each of the images in FIGS. 15 to 17.

Images A, B and C shown in the table of FIG. 18 refer to FIGS. 15, 16 and 17, respectively.

The table of FIG. 18 shows, for each of the images A, B and C, “foreground area after preprocessing” (i.e., the area of the stem region obtained from the image after image preprocessing), “area after removing yellow component” (i.e., the area of green component remaining after removing yellow to brown color components) and “green component tone percentage value” (i.e., the tone percentage value of green component), which are the values obtained in the tone calculation process 33a, “dimensional measurement”, which is the value obtained in the dimension calculation process 33b, “tone value”, “dimensional value” and “degree of climacteric ripeness”, which are the values obtained in the climacteric ripeness degree calculation process 33c.

These values were verified, and all the results were found to be accurate.

### Ripeness Determination Unit 34

As described above, the ripeness determination unit 34 shown in FIG. 1 performs a process (ripeness determination process) to determine whether the melon is ripe to eat based on the degree of climacteric ripeness determined by the climacteric ripeness degree determination unit 33.

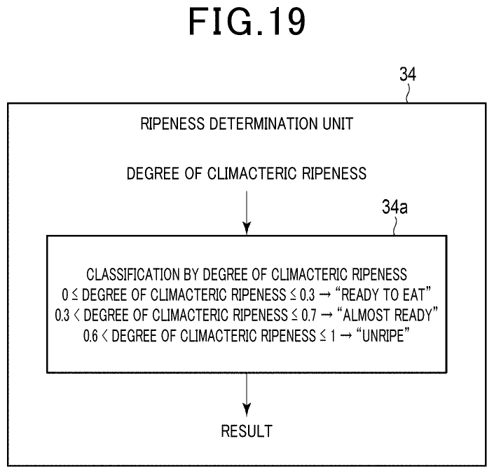

FIG. 19 is a diagram illustrating an example of a procedure of the ripeness determination process performed by the ripeness determination unit 34.

The above-mentioned climacteric ripeness degree determination unit 33 calculates a degree of climacteric ripeness represented in the range of 0 or greater and 1 or less.

The ripeness determination unit 34 determines one of three classes, for example, “ready to eat,” “almost ready” and “unripe,” depending on the degree of climacteric ripeness. For this purpose, the possible range of the degree of climacteric ripeness, which is 0 or greater and 1 or less, is divided into a plurality of classes (a plurality of ranges), so that the ripeness determination result (either “ready to eat,” “almost ready” or “unripe”) can be obtained from the degree of climacteric ripeness in each class. For example, classification is performed as shown in step 34a in FIG. 19. Then, the ripeness determination result is output according to which class the degree of climacteric ripeness belongs to.

In the above example, classification is made into three classes, “ready to eat,” “almost ready” and “unripe,” but more detailed classification may be performed.

### Result Output Unit 35

As described above, the result output unit 35 shown in FIG. 1 performs a process (result output process) to notify the terminal 1 of the result (ripeness determination result) determined by the ripeness determination unit 34.

The result output process outputs the ripeness determination results, as well as the results calculated in the climacteric ripeness degree determination process (degree of climacteric ripeness, tone percentage value, dimensional measurement, and the like). If necessary, other numerical values and various images (for example, images shown in FIGS. 15 to 17) may be output. This information is sent from the server 1 to the terminal 2 via the communication devices 12 and 24, and displayed on the display device 25.

### Modified Examples

Next, modified examples of the system shown in FIG. 1 will be described.

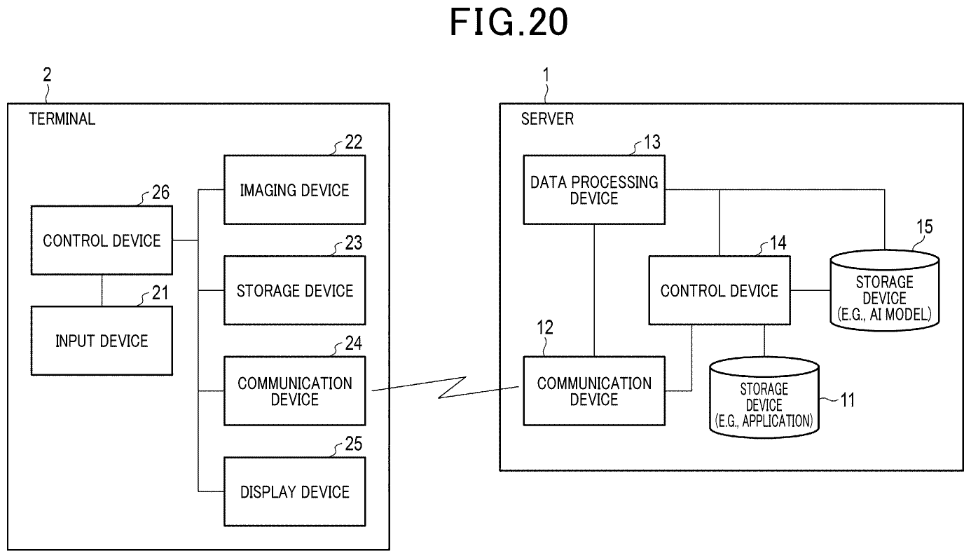

FIG. 20 is a diagram illustrating a modified example of the system shown in FIG. 1. In FIG. 20, components common to those in FIG. 1 are denoted by the same reference signs, and repeated description is omitted.

The system in FIG. 20 differs from the system in FIG. 1 in that the server 1 further includes a storage device 15. The storage device 15 stores the AI model described below and various related data. The data processing device 13 performs information processing using the AI model and various related data, under the control of the control device 14. Further, AI technology described below is applied to the climacteric ripeness degree determination process and the ripeness determination process performed by the ripeness determination system 30 shown in FIG. 2.

### Application of AI Technology

In this example, AI technology is used to obtain a more accurate degree of climacteric ripeness or ripeness determination results. For this purpose, an AI model is created in advance, and a large number of images are input into the AI model for training. The AI model here refers to an inference model created by deep learning using images.

Further, in this example, a task (image classification task) is used that performs classification (for example, classification into “ready to eat,” “almost ready” and “unripe”) based on the feature amount of the image. The image classification task is used to create an inference model by deep learning, and the inference model is used to make inference.

When creating an AI model, it is preferred that AI is trained on images under certain conditions, such as using the same background (for example, using a common mount P) for the region other than the target object (melon stem). For example, when an image of the target object is captured using the above mount P and then the image is preprocessed, only the target object can be easily imaged in a predetermined region.

By storing a large number of images thus captured in a predetermined storage device and creating an AI model using these images, it is possible to perform accurate inference using the AI model and obtain accurate degree of climacteric ripeness or ripeness determination results.

The following describes a process from creation to execution of an AI model.

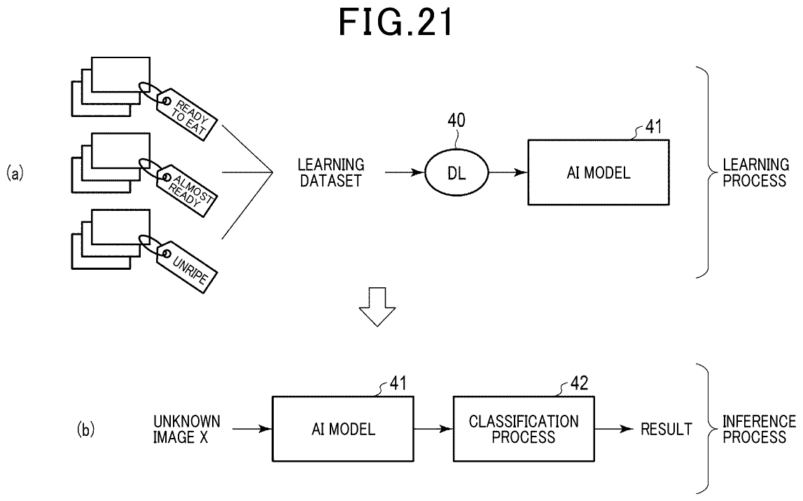

FIG. 21 is a diagram schematically illustrating a procedure for obtaining a degree of climacteric ripeness or ripeness determination result using an AI model.

The process shown in FIG. 21 is roughly divided into a learning process to develop the determination capability as an AI and an inference process to actually perform determination. In FIG. 21, (a) shows the flow of the learning process, and (b) shows the flow of the inference process.

In the learning process, each image is assigned to a “class,” which is the final answer to be classified by the AI, and a large number of images are prepared for each class. This is called a dataset.

In this example, a learning dataset composed of a large number of images of melon stems that have been pre-labeled as “ready to eat,” “almost ready” and “unripe” is prepared.

Based on such a dataset, an AI model 41 (trained model) is created by deep learning 40 using any deep learning method. The deep learning method here refers to image classification by an image classification task.

The method for creating an AI model may be a method of creating an AI model from scratch, or may be a method of transfer learning to adapt an existing model on the network to its own requirements.

In the inference process, the created AI model 41 is used to perform inference on an unknown image X. In this example, the AI model 41 is used to perform a classification process 42 on an image X of a melon stem for which the degree of climacteric ripeness or ripeness determination result is to be actually measured, classify the image into “ready to eat,” “almost ready,” “unripe,” or the like, and output the corresponding (“ready to eat,” “almost ready,” “unripe,” or the like) as the result.

### Effect of Applying AI Technology

This system focuses on the melon stem in the captured image, and uses image processing technology to quantify two features, color and shape of the melon stem, to calculate a final degree of climacteric ripeness. In addition, an AI model created using images captured under the same conditions can be used to make comprehensive determination, further improving accuracy and versatility. In general, increasing the number of images for learning can create a general-purpose AI that can handle various cases, and the more datasets used for learning, the better the overall determination accuracy.

### Operation Example of Ripeness Determination System 30

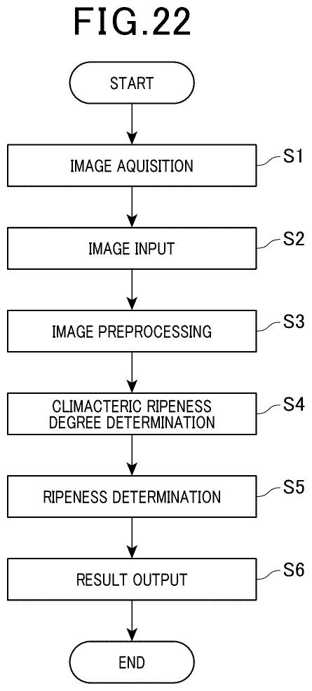

With reference to a flowchart in FIG. 22, an example of a basic operation of the ripeness determination system 30 will be described.

First, the image acquisition unit 31 acquires an image of a melon stem from the terminal 1 (image acquisition process) (step S1).

Next, the image input unit 32 performs a process (image input process) of inputting the image acquired by the image acquisition unit 31 (step S2).

The image preprocessing unit 32 processes the image obtained from the image input unit 32 (image preprocessing) before it is used by the climacteric ripeness degree determination unit 33 (step S3).

Next, the climacteric ripeness degree determination unit 33 obtains information on the color and shape of the stem from the image of the stem processed by the image preprocessing unit 32, and performs a process (climacteric ripeness degree determination process) to determine a degree of climacteric ripeness of the melon based on the obtained information on the color and shape (step S4).

Next, the ripeness determination unit 34 performs a process (ripeness determination process) to determine whether the melon is ripe to eat based on the degree of climacteric ripeness determined by the climacteric ripeness degree determination unit 33 (step S5).

Next, the result output unit 35 performs a process (result output process) to notify the terminal 1 of the result determined by the ripeness determination unit 34 (step S6).

### Effects of Embodiments

The effects of the embodiments will be described below.

### Improvement in Accuracy of Ripeness Determination

In the embodiments, the melon stem is focused to determine the degree of climacteric ripeness, and the dimensional value (thickness) and the tone value (color components) of the stem are quantified to determine the degree of climacteric ripeness and whether the melon is ripe to eat. While typical climacteric ripeness degree determination systems have a single criterion, the present system has two criteria (three criteria when the above AI technology is added), making it possible to make a determination based on a plurality of criteria. Therefore, even if one criterion has a large error due to individual differences or the like, the other criterion can be used for determination, and the determination accuracy can be relatively improved.

### Determination System Based on Preferences

In the embodiments, the climacteric ripeness degree determination unit 33 calculates the degree of climacteric ripeness of the melon based on the results obtained by quantifying the features that changes over time with the progress of climacteric ripening of the melon, and the ripeness determination unit 34 performs the final ripeness determination based on whether a predetermined determination threshold is exceeded. Here, the determination threshold refers to the average value at the time when the fruit portion of the melon becomes soft and easy to eat, but by setting different determination thresholds corresponding to preferences of those who prefer soft melons and those who prefer hard melons, it is possible to provide a ripeness determination system that can accommodate consumers with a variety of preferences.

### Few Environmental Constraints

In the embodiments, one option is to prepare a melon with a predetermined mount P attached to the stem S and capture an image while aligning a guide displayed on a dedicated application with the mount P. The mount P may be, for example, about 3 cm to 5 cm square, and have a background color that facilitates the subsequent background adjustment process 32d. In the determination systems that use images, there may be restrictions on the environment during image capture, such as the need to capture images against a black background in order to recognize components other than the object being measured as the background and perform conversion. On the other hand, in the embodiments, image capture is performed with the mount P attached to the melon, so components other than the stem of the melon are not captured in the image. As a result, ripeness determination can be performed more easily compared with conventional methods, without environmental constraints.

### Measurement can be Performed at any Time

In the embodiments, it is possible to determine whether the melon is ripe to eat at the moment when the ripeness determination system is used. In addition, the ripeness determination system can be used at any time. Therefore, actual users such as consumers can easily know at any time whether the melon is ripe to eat.

As described above in detail, according to the above embodiments, it is possible to easily determine whether the melon is ripe to eat.

The present invention is not limited to the embodiments as described above, and the components can be modified and embodied when implemented, without departing from the spirit of the invention. Further, a plurality of components disclosed in the above embodiments can be appropriately combined to form various inventions. For example, some components may be removed from all the components shown in the above embodiments. Furthermore, components from different embodiments can be appropriately combined.

1. A ripeness determination system, comprising:
processing circuitry configured to
determine a degree of climacteric ripeness of a melon based on at least two factors obtained from an image of a stem of the melon, and
determine whether the melon is ripe to eat based on the degree of climacteric ripeness.

2. The ripeness determination system according to claim 1, wherein
the processing circuitry is configured to use the image of the stem to calculate a percentage of a color of the stem that increases or decreases with progress of climacteric ripening of the melon.

3. The ripeness determination system according to claim 1, wherein
the processing circuitry is configured to use the image of the stem to calculate a thickness dimension of the stem.

4. The ripeness determination system according to claim 1, wherein the processing circuitry is configured to
obtain information on a color of the stem and information on a thickness dimension of the stem from the image of the stem, and
determine a degree of climacteric ripeness of the melon based on the obtained information on the color and information on the thickness dimension.

5. The ripeness determination system according to claim 4, wherein
the processing circuitry is configured to use the information on the color of the stem and the information on the thickness dimension of the stem and information on the degree of climacteric ripeness of the melon obtained using AI (Artificial Intelligence) technology to determine a degree of climacteric ripeness of the melon.

6. The ripeness determination system according to claim 1, wherein the processing circuitry is configured to acquire an image of the stem with a mount attached to a rear side of the stem.

7. The ripeness determination system according to claim 6, wherein
the processing circuitry is configured to acquire an image while aligning a first frame pre-marked on the mount with a second frame displayed on a display device of a terminal.

8. The ripeness determination system according to claim 6, wherein the processing circuitry is configured to
process the image acquired before the image is used to determine the degree of climacteric ripeness of the melon, and
extract a predetermined region from the image to be processed.

9. The ripeness determination system according to claim 8, wherein
the processing circuitry is configured to change an image portion corresponding to a background of the stem of the image to be processed to a specific color according to a color of the mount.

10. The ripeness determination system according to claim 8, wherein
the processing circuitry is configured to move the stem in the image to be processed to a center of the image and rotate the stem to orient a longitudinal direction of the stem in a predetermined direction.

11. A ripeness determination method, comprising:
determining, by processing circuitry, a degree of climacteric ripeness of a melon based on at least two factors obtained from an image of a stem of the melon; and
determining, by the processing circuitry, whether the melon is ripe to eat based on the degree of climacteric ripeness.

12. The ripeness determination method according to claim 11, further comprising:
using the image of the stem to calculate a percentage of a color of the stem that increases or decreases with progress of climacteric ripening of the melon.

13. The ripeness determination method according to claim 11, further comprising:
using the image of the stem to calculate a thickness dimension of the stem.

14. The ripeness determination method according to claim 11, further comprising:
obtaining information on a color of the stem and information on a thickness dimension of the stem from the image of the stem; and
determining a degree of climacteric ripeness of the melon based on the obtained information on the color and information on the thickness dimension.

15. The ripeness determination method according to claim 14, further comprising:
using the information on the color of the stem and the information on the thickness dimension of the stem and information on the degree of climacteric ripeness of the melon obtained using AI (Artificial Intelligence) technology to determine a degree of climacteric ripeness of the melon.

16. The ripeness determination system method according to claim 11, further comprising:
acquiring an image of the stem with a mount attached to a rear side of the stem.

17. The ripeness determination method according to claim 16, further comprising:
acquiring an image while aligning a first frame pre-marked on the mount with a second frame displayed on a display device of a terminal.

18. The ripeness determination method according to claim 16, further comprising:
processing the image acquired before the image is used to determine the degree of climacteric ripeness of the melon; and
extracting a predetermined region from the image to be processed.

19. The ripeness determination method according to claim 18, further comprising:
changing an image portion corresponding to a background of the stem of the image to be processed to a specific color according to a color of the mount.

20. The ripeness determination method according to claim 18, further comprising:
moving the stem in the image to be processed to a center of the image and rotating the stem to orient a longitudinal direction of the stem in a predetermined direction.
